(19) United States
(12) Patent Application Publication
(10) Pub. No.: US 2008/0225661 A1
(43) Pub. Date: Sep. 18, 2008

(54) Optical Apparatus Capable of Generating Adaptive Control Signals

(75) Inventors: Mohamad-Hussein El Husseini, Brussels (BE); Stefan Geusens, Eindhoven (NL); Jeroen Arnoldus Leonardus Johannes Raaymakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,534

(22) PCT Filed: Jun. 28, 2006
(86) PCT No.: PCT/IB2006/052168

§ 371 Date: Jan. 3, 2008

(30) Foreign Application Priority Data
Jul. 5, 2005 (EP) 05106070.5

(51) Int. Cl. G11B 5/58

(52) U.S. Cl. 369/53.17

(57) ABSTRACT

The present invention discloses an optical apparatus capable of reproducing/recording information from/to an optical carrier, e.g. a DVD or BD disk. The apparatus has control means for positioning/focusing a radiation beam (5) on the carrier and photo detection means for detection of radiation reflected from the carrier. Additionally, defect detection means (DEFO) for detection of surface defect areas (A1, A2) can indicate where surface defects, e.g. scratches etc., are present. Processing means are adapted for integrating, and preferably differentiate, error signals (RE, FE) immediately after the beam (5.b) is exiting a defect area (A1) for generating adaptive control signals (AD_RE, AD_FE). The optical system is adapted to apply the adaptive control signals (AD_RE, AD_FE) when the beam is positioned in the defect area (A1) again, thereby reducing off-track deviation as the beam (5.d) exits the defect area (A1).

The present invention relates to an optical apparatus capable of reproducing/recording information from/to an optical carrier, e.g. a CD, DVD, HD-DVD or BD disk. The optical apparatus is capable of generating adaptive control signals in response to surface defects on the carrier. The present invention also relates to a corresponding method for operating an optical apparatus.

Optical storage of information on optical disk media, such as CD, DVD and BD, is being increasingly used in more and more applications. The information or the data is arranged in spiral-like tracks and written on and/or read from the optical disk media by a laser unit, the laser unit being positioned in an optical drive device.

Optical disk media will inevitably contain surface defects due to e.g. careless handling by the user and/or manufacturing imperfections. Various kinds of surface defect are known, see e.g. WO 2004/07321 to the same applicant for a categorization scheme of different surface defects; scratches, black dots, finger prints, WO 2004/07321 hereby being incorporated by reference in its entirety. Thus, robust playability and recordability performance of disks with surface defects is an important aspect of optical storage. Several defects management methods are applied to deal with disk surface defects.

However, hitherto proposed solutions have limited performance: the proposed solutions either intervene too late to account for a track-loss situation, or alternatively hinder the overall system performance when fast track-loss detection is absolutely needed. Therefore, the actual state-of-the-art in track-loss handling is a trade-off between fast track-loss detection and overall system performance.

One such proposed solution is disclosed in U.S. Pat. No. 6,198,085. In that reference, a repeat control apparatus is applied in an optical drive in order to perform a repeat control on a control signal, e.g. a focus error signal (FE). The repeat control apparatus has storage means for storing previous values of the control signal and a defect detecting device for detecting a surface defect on the disk. The storage means are adapted to generate a compensation control signal in case that a damaged control signal occurs due to a defect on the disk. The repeat control apparatus is suited for compensating a repetitive error, i.e. an extended surface defect that occurs again and again due to the revolution of the disk. However, the compensation control signal may also be applied based on just the previous rotation. The compensation signal is then based on interpolated values of the control signal immediately before and after the surface detect, thereby “bridging” over the damaged area. This has the drawback that extended use of memory devices for storage of the control signal is needed and computational resources for the interpolation must be allocated.

Hence, an improved optical apparatus would be advantageous, and in particular a more efficient and/or reliable optical apparatus with respect to surface defects on the optical media would be advantageous.

Accordingly, the invention preferably seeks to mitigate, alleviate or eliminate one or more of the above mentioned disadvantages singly or in any combination. In particular, it may be seen as an object of the present invention to provide an optical apparatus that solves the above mentioned problems of the prior art with surface defects on an optical carrier.

This object and several other objects are obtained in a first aspect of the invention by providing an optical apparatus capable of reproducing/recording information from/to an associated optical carrier, the apparatus comprising:

control means capable of positioning and focusing a radiation beam on the associated optical carrier, the associated optical carrier comprising optical readable effects arranged in tracks and/or being adapted for recording optical readable effects,

photo detection means for detection of radiation reflected from the associated optical carrier, said photo detection means being adapted for generating error signals (RE, FE) indicative of a difference between a target position and an actual position of the focussed radiation beam on the carrier,

a servomechanism adapted to change the position of the focussed radiation beam on the associated optical carrier in response to at least one of said error signals (RE, FE) by generating corresponding control signals (R_act, F_act) and applying said control signals (R_act, F_act) on the control means,

defect detection means (DEFO) for detection of one or more defect areas (A1, A2) on the associated optical carrier, and

processing means adapted for integrating one or more error signals (RE, FE) as the focussed radiation beam is exiting a first defect area (A1), as indicated by the defect detection means (DEFO), for generating one or more adaptive control signals (AD_RE, AD_FE), said first defect area (A1) being positioned in a first track (T1),

wherein the optical system is adapted to apply the one or more adaptive control signals (AD_RE, AD_FE) on the control means when the focussed radiation beam is positioned in the first defect area (A1) again on a subsequent, second track (T2), said first (T1) and second (T2) tracks being adjacent tracks on the associated optical carrier.

The invention is particularly, but not exclusively, advantageous for obtaining an optical apparatus capable of having a reduced, possibly eliminated, risk of track-loss upon crossing a surface defect. Moreover, the present invention provides a simple and efficient way of handling surface defects because of the reduced need for memory units and/or computation devices otherwise needed of many hitherto known counter-defect measures. Despite the relatively simple means, the present invention ensures an efficient surface defect handling because each surface defect is balanced by a unique and adaptive control signal.

In combination with surface defects, it has been realized by the inventors that the present invention may additionally or alternatively provide a defect handling method for some repetitive defects that are not commonly known as surface defects, one such example being eccentricity error which is due to the fact that the rotational axis of the optical carrier does not coincide with its geometrical axis. Thus, eccentricity may enhance the malfunctioning effect in case of surface defects, but this may, at least in part, be remedied by the present invention.

In context of the present invention, the integrating of the one or more error signals (RE, FE) when the focussed radiation beam is exiting a first defect area (A1) is performed by sampling and accumulating the value of the one or more error signals in dedicated storage means, e.g. an integrator (INT), of the processing means. Such sampling and accumulating of error signals is routinely performed in present days state-of-the-art optical drives, but for application in the present invention only one sample for each error signal immediately after leaving the first defect area (A1) is relevant. The said integration may e.g. be performed by an integrator part of a proportional-integrate-differentiate (PID) circuitry.

Preferably, the optical system may be adapted to apply the one or more adaptive control signals (AD_RE, AD_FE) on the control means when the focussed radiation beam enters the first defect area (A1). This may be determined by defect detection means (DEFO) or alternatively or additionally by timing information and/or address information obtained by/from the optical system and/or the optical carrier. Alternatively, the optical system may be adapted to apply the one or more adaptive control signals (AD_RE, AD_FE) on the control means immediately before the focussed radiation beam enters the first defect area (A1). It is further contemplated that the one or more adaptive control signals (AD_RE, AD_FE) may be applied on the control means when the focussed radiation beam is positioned in the first defect area (A1) but delayed by a predetermined time delay relative to the entry time in the first surface defect (A1).

In a particular embodiment, the integrated value of the one or more error signals (RE, FE) may be multiplied by a gain constant so as to generate the one or more adaptive control signals (AD_RE, AD_FE). The gain constant may be dependent on the duration of the adaptive control signals. In general, the product of the duration and the amplitude of the adaptive control signal is adapted to deliver the necessary energy to counter or compensate the drift of the radiation beam as the beam exits the defect area. Typically, the gain constant is in the range from zero to 100 (gain constant being dimensionless).

In a particular embodiment, the processing means may be further adapted for differentiating one or more error signals (RE, FE) as the focussed radiation beam exits the first defect area (A1) for generating one or more adaptive control signals (AD_RE, AD_FE). The differentiation of one or more error signals is to be performed immediately after the radiation beam exits the defect area. Preferably, the one or more adaptive control signals (AD_RE, AD_FE) may comprise a substantially square-shaped pulse. Alternatively, the one or more adaptive control signals (AD_RE, AD_FE) may comprise two substantially square-shaped pulses having opposite polarity. Having performed said differentiation yet another constraint as a supplement to the performed integration of the one or more error signals is provided. This allows the adaptive control signals to have two degrees of freedom and a corresponding broad range of shapes, time dependency etc. is possible.

The one or more adaptive control signals (AD_RE, AD_FE) may advantageously be adapted so that the position of the focussed radiation beam is substantially on said second track (T2) as the focussed radiation beam leaves the first defect area (A1). Thus, there is a near zero or zero off track deviation upon leaving the defect area. Additionally, the one or more adaptive control signals (AD_RE, AD_FE) may be adapted so that the focussed radiation beam has substantially zero velocity in a direction perpendicular to said second track (T2) as the focussed radiation beam leaves the first defect area (A1). Thus, the radiation beam has a near-zero or zero radial velocity upon leaving the defect area. Such adaptive control signals may be obtained by e.g. modelling, as it will be explained in more detail below.

In a second aspect, the invention relates to method for operating an optical apparatus, the method comprising the steps of:

1) positioning and focusing a radiation beam on the associated optical carrier by control means, the associated optical carrier comprising optical readable effects arranged in tracks (T1, T2) and/or being adapted for recording optical readable effects,
2) detection radiation reflected from the associated optical carrier by photo detection means, said photo detection means being adapted for generating error signals (RE, FE) indicative of a difference between a target position and an actual position of the focussed radiation beam on the carrier,
3) providing a servomechanism adapted to change the position of the focussed radiation beam on the associated optical carrier in response to at least one of said error signals (RE, FE) by generating corresponding control signals (R_act, F_act) and applying said control signals (R_act, F_act) on the control means,
4) detection of one or more surface defect areas (A1, A2) on the associated optical carrier by defect detection means (DEFO),
5) integrating one or more error signals (RE, FE) by processing means as the focussed radiation beam is exiting a first defect area (A1), as indicated by the defect detection means (DEFO), for generating one or more adaptive control signals (AD_RE, AD_FE), said first defect area (A1) being positioned in a first track (T1), and
6) applying the one or more adaptive control signals (AD_RE, AD_FE) on the control means when the focussed radiation beam is positioned in the first defect area (A1) again on a subsequent, second track (T2), said first (T1) and second (T2) tracks being adjacent tracks on the associated optical carrier.

The invention according to this aspect is particularly, but not exclusively, advantageous for providing a method for operating an optical apparatus having a robust playability and/or recordability of information from/to an optical carrier. Furthermore, the present invention has the benefit that hitherto known components/parts are applied in a new and advantageous manner resulting in a fast and efficient implementation in optical drives to be manufactured in the near future.

In a third aspect, the invention relates to a computer program product being adapted to enable a computer system comprising at least one computer having data storage means associated therewith to control an optical apparatus according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical apparatus may be changed to operate according to the present invention by installing a computer program product on a computer system controlling the said optical apparatus. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

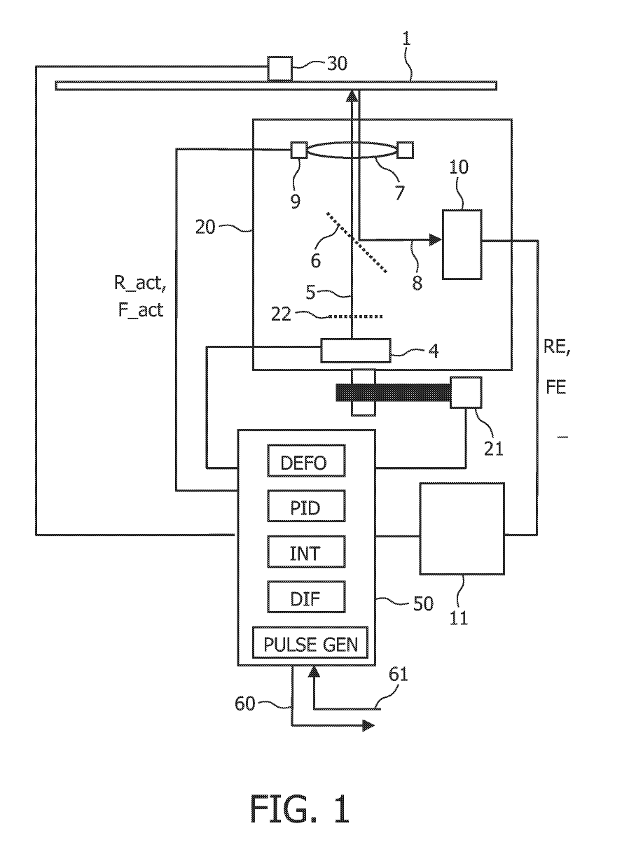

FIG. 1 is a schematic diagram of an embodiment of an optical apparatus according to the present invention,

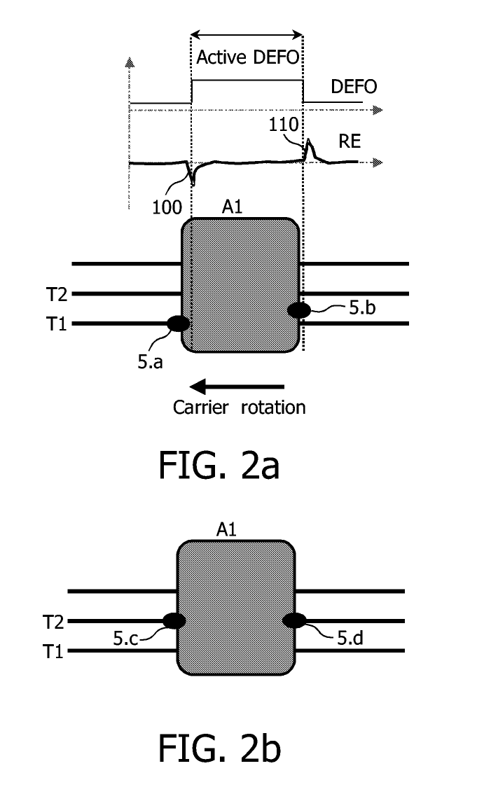

FIG. 2 illustrates a defect area (A1) on an optical carrier,

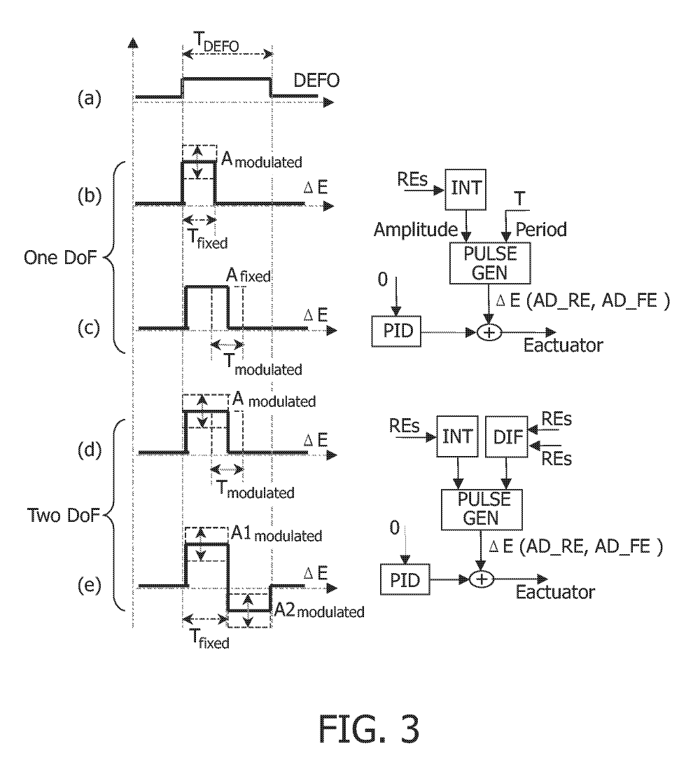

FIG. 3 shows graphs of various adaptive control signals according to the present invention,

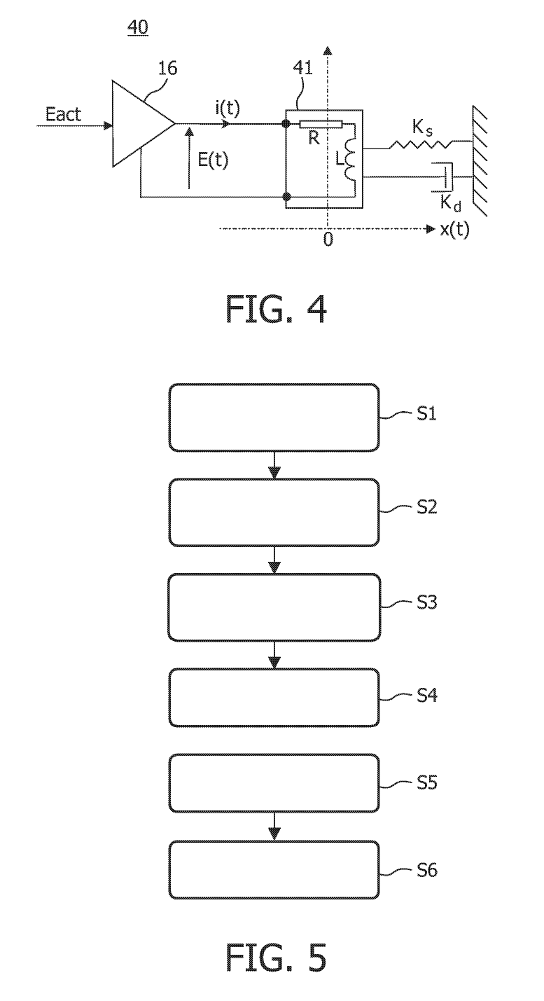

FIG. 4 illustrates an electro-mechanical model of an actuator of control means according to the present invention, and

FIG. 5 is a flow-chart of a method according to the invention.

FIG. 1 shows an optical apparatus and an optical information carrier 1 according to the invention. The carrier 1 is fixed and rotated by holding means 30.

The carrier 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 1.

The apparatus comprises an optical head 20, sometimes called an optical pickup (OPU), the optical head 20 being displaceable by actuation means 21, e.g. an electric stepping motor. The optical head 20 comprises a photo detection system 10, a radiation source 4, a beam splitter 6, an objective lens 7, and lens displacement means 9. The optical head 20 may also comprises beam splitting means 22, such as a grating or a holographic pattern that is capable of splitting the radiation beam 5 into at least three components for use in the three spot differential push-pull radial tracking, or any other applicable control method. For clarity reason, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 1 for clarity.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of error signals i.e. focus FE and radial tracking RE errors in the pre-processor 11. Thus, the pre-processor 11 transmits focus FE and radial tracking error RE signals to the processor 50 where commonly known servomechanism operated by usage of PID control means (proportional-integrate-differentiate) is applied for controlling the radial position and focus position of the radiation beam 5 on the carrier 1.

The photo detection system 10 can also transmit a read signal or RF signal representing the information being read from the carrier 1 to the processor 50 through the pre-processor 11. The read signal may possibly be converted to a central aperture (CA) signal by a low-pass filtering of the RF signal in the processor 50.

The radiation source 4 for emitting a radiation beam 5 can for example be a semiconductor laser with a variable power, possibly also with variable wavelength of radiation. Alternatively, the radiation source 4 may comprise more than one laser.

The optical head 20 is optically arranged so that the radiation beam 5 is directed to the optical carrier 1 via a beam splitter 6, and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses output signals from the pre-processor 11. The processor 50 can also output control signals to the actuation means 21, the radiation source 4, the lens displacement means 9; F_act and R_act, the pre-processor 11, and the holding means 30, as illustrated in FIG. 1. Similarly, the processor 50 can receive data, indicated at 61, and the processor 50 may output data from the reading process as indicated at 60. In the context of the present invention, the collective term “control signals” is considered to comprise both radial control signals R_act and focus control signals F_act, and the collective term “control signal” is abbreviated E_act.

Displacement of the lens 7 in a radial direction of the carrier 1 is performed on two levels by the actuators 9 and 21. The actuator 9 is used for “fine” positioning (nanometer precision), whereas the actuator 21 is applied to the “coarse” positioning (micrometer precision) using e.g. a stepping motor. The adaptive control signals applied in the context of the present invention are generating by pulse generation means PULSE GEN, said pulse generation means being capable of outputting signals for controlling the actuator 9, i.e. the fine positioning. However, the adaptive control signals are not limited to such use.

In particular, the processor 50 comprises defect detection means DEFO for detection of one or more defect areas A1 and A2 (not shown) on the carrier 1 see FIG. 2. Essentially, the DEFO continuously monitor several error signals, mainly a low-filtered version of the RF signal to determine if any of the monitored signals exceeds or drops below a certain predetermined value resulting in a positive indication of a surface defect A1, e.g. a scratch. Specifically, the DEFO may monitor the amplitude of the enveloped RF signal. More details about defect detection means may be found in U.S. Pat. No. 4,682,314, which is hereby incorporated by reference in its entirety. The DEFO is capable of detecting several defect areas A1, A2, A3 and so forth.

Upon positive identification of a surface defect, typically within a short delay in the order of 20-40 microseconds depending on the rotational speed of the carrier 1 and the DEFO settings it is commonly used in the art to cease the active operation of one or more servomechanisms based on the error signals RE and FE, e.g. by setting the error signals to zero until the radiation beam 5 is not anymore positioned in the surface defected area. In the context of the present invention, the DEFO additionally serves the purpose of initiate the sampling of one or more samples from the radial error signal RE and/or focus error signal FE, said samples being intended for integrating one or more error signals RE and FE from a defect area A1 when the focussed radiation beam 5 leaves or exits the defect area A1 by the integration means INT of the processing means 50.

The processor 50 further comprises processing means that are further adapted for differentiating by differentiating means DIF i.e. a differentiator, of one or more error signals RE and FE from a defect area A1 as the focussed radiation beam 5 is positioned substantially at the periphery of the defect area A1 for generating one or more adaptive control signals AD_RE and AD_FE. Thus, from at least two values of RE or FE obtained preferably at an exit position, or near after, of the radiation beam 5 on the surface defect A1, a slope of an error signal RE or/and FE is obtained. The one or more slopes are used for generating adaptive control signals AD_RE and AD_FE as will be explained below.

FIG. 2 illustrates a defect area signal A1 on an optical carrier 1, the carrier having a first track T1 and a second track T2 both having a portion positioned in the defect A1. In FIG. 2A, the beam 5 is positioned on the first track while in FIG. 2B the beam 5 is positioned on the second track T2. An entry and exit position of the beam 5 relative to the defect A1 is schematically indicated for both tracks. The carrier 1 rotates from right to left in FIG. 2 as indicated by the bold arrow causing the beam 5 to have a relative movement from right to left in FIG. 2. In FIG. 2A, the DEFO signal and the radial error signal are also shown on a superimposed time scale.

As shown in FIG. 2A, the radiation beam 5.a is about to enter the defect area A1. As the DEFO indicates that the beam 5 is positioned in A1 the processor 50 stops radial and focus servo loops as soon as possible, thus setting RE to zero. However, before said loops are stopped, the loops have typically caused errors in position and focus as also indicated by the corrupted error signal portion 100, i.e. the beam 5.b becomes displaced from a central position on the track T1. Inside the defect A1, the beam 5 continues to drift off the track T1 and may possibly end up on the next track T2 at the exit of the defect at 5.b. This will produce an error in the process of recording/reproduction of information on/from the carrier 1. It is also possible that the beam 5 exits the defect at 5.b with large off-track drift in position and radial velocity. After the DEFO is deactivated and the servo loops are re-started the radial error signal exhibit a transient behavior as shown by the error signal portion 110. This causes a delay in re-catching the track and, therefore, a delay in recording/reproduction of information from the carrier 1 as the beam 5.b has to be repositioned. This recapture delay is typically in the order of 100 microseconds to 1 millisecond. In FIG. 2A, it should be noted that there is also a small delay both for the activation of the DEFO and for the deactivation of the DEFO. This is indicated by the two horizontal lines being parallel with the rising and the falling edge, respectively, of the DEFO signal, but the two lines are being positioned to the right of the start of A1 and to right of the end of A1, respectively. However, the indicated delays of FIG. 2A need not always be present.

In FIG. 2B, the beam 5.c re-enters the defect area A1. Similarly to the situation of FIG. 2A, the servo loops are stopped. According to the present invention, adaptive control signals AD_RE and AD_FE are now applied to the control means, i.e. actuator 9, to prevent or counter any off track displacement away from a central position on the second track T2. Therefore, the beam 5.d will not suffer from any off track displacement upon leaving defect area A1, thus beam 5.d is substantially positioned on the second track T2. Preferably, the beam 5.d does not have velocity component in a direction perpendicular to the track T2 immediately after leaving the defect area A1.

A key parameter of the present invention is the adaptive control signal AD_RE and AD_FE to be applied on the control means 9 when the focussed radiation beam 5 and 5.c is positioned in the first defect area A1 again on the subsequent, second track T2.

FIG. 3 shows graphs of various adaptive control signals according to the present invention as a function of time together with a response of defect detection means DEFO indicating a defect for a period of time T_{DEFO} in FIG. 3 (a). The adaptive control signals AD_RE and AD_FE are commonly abbreviated ΔE in FIG. 3.

FIGS. 3 (b) and 3 (c) are embodiments of adaptive control signals AD_RE and AD_FE having one degree of freedom (DoF). Thus, giving the integrated value of the error signal, the adaptive control signal AD_RE or AD_FE is generated. The adaptive control signals of FIGS. 3 (b) and 3 (c) is a substantially square-shaped pulse where the amplitude is modulated and the period is fixed, or alternatively the amplitude is fixed and the period is modulated. In a particular embodiment, the period of the adaptive control signal is equal to the T_{DEFO}, but any predetermined value such as 0.1, 0.2, 0.3, 0.4, 0.5, 0.6, 0.7, 0.8, or 0.9 times T_{DEFO} may be applied.

For the embodiments shown in FIG. 3 (b), the fixed period may also be defined by a fixed time base. The fixed time base should be shorter than the period where the DEFO is active. The fixed time base is preferably 1, 2, 5, 10, 20, 30, 40, 50, 60, 70, 80, 90 or 100 microseconds.

FIGS. 3 (d) and 3 (e) are embodiments of adaptive control signal AD_RE and AD_FE having two degrees of freedom (DoF). Two degrees of freedom is feasible if the differentiating of the error signals of the previous round of rotation of the carrier 1 is performed. The differentiation should be performed by taking two (or more) samples of the error signals RE and FE immediately after the laser beam 5 exits the defect A1 at 5.b. The differentiation may alternatively be performed as soon as the error signals RE and FE are reliable, i.e. the samples taken may be taken after one or more processor cycles to ensure that the taken samples of RE and FE are reliable. This also applies for the case with one degree of freedom. The obtained differentiated value of the error signal at the exit of the defect A1 will provide an indication of the velocity of the radiation beam 5.b that may be applicable for generating the adaptive control signal in order to reduce, possibly eliminate, the radial velocity of the beam 5.d.

For the embodiment shown in FIG. 3 (d), the adaptive control signal is a substantially square-shaped pulse that may have both a variable amplitude and a variable period. The resulting pulse is adapted to minimize off-track deviation and zero radial velocity of the radiation beam 5.d upon exiting the defect area A1.

For the embodiment shown in FIG. 3 (e), the adaptive control signal comprises two square-shaped pulses of opposite polarity. The fixed period may in this case be set to a predetermined value such as 0.1, 0.2, 0.3, 0.4, 0.5, 0.6, 0.7, 0.8, or 0.9 times T_{DEFO}. The two corresponding amplitudes may then be modeled so that the resulting pulse is adapted to minimize off-track deviation and zero radial velocity of the radiation beam 5.d upon exiting the defect area A1. One example of an appropriate model that may be applied for obtaining adaptive control signals according to the present invention is now presented. However, the teaching of the present invention is not limited to this specific model.

For the embodiment shown in FIG. 3 (e), the fixed period separating the two pulses may also be defined by a fixed time base. The fixed time base should be shorter than the period where the DEFO is active. The fixed time base is preferably 1, 2, 5, 10, 20, 30, 40, 50, 60, 70, 80, 90 or 100 microseconds.

To the right of FIGS. 3 (b) and (c), and FIGS. 3 (d) and (e) are also shown respective block diagrams of the generation of adaptive control signals ΔE for the case of one degree of freedom and two degrees of freedom (DoF). Thus, for one DoF the pulse generator PULSE GEN receives an integrated value of e.g. RE from the integrator INT, while for two DoF the pulse generator PULSE GEN additionally receives a differentiate value from the differentiator DIF.

FIG. 4 illustrates an electro-mechanical model 40 of the actuator 9 of the control means, said electro-mechanical model comprising a moving part 41, a resistor R, an inductor L, a spring Kₛ and a damping element K_{d}. The electrical part of the electro-mechanical model 40 is supplied with a voltage E(t) and a current i(t). The position of the moving part 41 is given by x(t). An amplifier means 16 also depicted in FIG. 4 generates the voltage E(t) and the current i(t) when supplied with the servo signal Eact. The electro-mechanical model 40 can be modelled with the equations Eq1, Eq2, Eq3 and Eq4 given below. Many solutions fulfilling the model here presented may be applicable within the teaching of the present invention. Without being limited to any specific solutions the adaptive control signals resulting from such modelling may comprise trigonometric functions, exponential functions, and polynomials of any order.

The mechanical position x(t) of the moving part is given as a solution to Eq1:

$$F ( t ) = m \frac{{d}^{2} x ( t )}{d {t}^{2}} + {K}_{d} \frac{d x ( t )}{d t} + {K}_{s} x ( t ) \qquad Eq 1$$

where:
F(t): is the total force applied on the actuator (the Lorenz force in this case) [N],
m: is the mass of the moving part of the actuator [kg],
K_{d}: is the damping constant [N·s/m],
Kₛ: is the spring constant [N/m].
The electro-mechanical relations are given by Eq2 and Eq3:

F(t)=K_{f}i(t) Eq2

$${E}_{MF} ( t ) = {K}_{e} \frac{d x ( t )}{d t} \qquad Eq 3$$

where:
i(t): is the current injected by the power drive into the coil [A],
E_{MF}(t): is the electromotive force generated by a coil moving in a magnetic field [V],
K_{f}: is a force constant [N/A],
Kₑ: is an electric constant [V·s/m].
The electrical relation are given by Eq4:

$$E ( t ) - {E}_{MF} ( t ) = L \frac{d i ( t )}{d t} + Ri ( t ) \qquad Eq 4$$

where:
E(t): is the applied voltage on the coil,
L: is the coil inductance,
R: is the coil resistance.

Solving equations Eq1 to Eq4 allows a precise reconstruction of the trajectories of the radiation beam 5 on the carrier 1 when a proportional gain of the amplifier 16 is assumed. The amplifier 16 receives a control signal E_act from the processor 50. The electro-mechanical system can be translated into the linear Laplace (frequency) domain with the servo signal E_act as input and the position of the moving part 41 X(s) as output.

FIG. 5 is a flow-chart of a method according to the invention. The method is applicable for operating an optical apparatus capable of reproducing/recording information from/to an associated optical carrier (1). The method comprises the steps of:

S1) Positioning and focusing a radiation beam 5 on the associated optical carrier by control means 9 and/or 21, the associated optical carrier comprising optical readable effects arranged in tracks T1 and T2 and/or being adapted for recording of optical readable effects, see FIG. 2.
S2) Detecting radiation 8 reflected from the associated optical carrier 1 by photo detection means 10, said photo detection means being adapted for generating error signals RE and FE indicative of a difference between a target position and an actual position of the focussed radiation beam on the carrier 1.
S3) Providing a servomechanism adapted to change the position of the focussed radiation beam 5 on the associated optical carrier in response to at least one of said error signals RE and FE by generating corresponding control signals R_act, F_act and applying said control signals R_act and F_act on the control means 9.
S4) Detection of one or more surface defect areas A1 and A2 on the associated optical carrier by defect detection means DEFO.
S5) Integrating one or more error signals RE and FE by processing means 50 as the focussed radiation beam 5.b, see FIG. 2, is exiting a first defect area A1, as indicated by the defect detection means DEFO, for generating one or more adaptive control signals AD_RE and AD_FE, said first defect area A1 being positioned in a first track T1. Thus, immediately after the DEFO does not indicate a surface defect is present, the processing means integrates the one or more error signals.
S6) Applying the one or more adaptive control signals AD_RE, AD_FE on the control means when the focussed radiation beam 5.c is positioned in the first defect area A1 again on a subsequent, second track T2, said first T1 and second T2 tracks being adjacent tracks on the associated optical carrier. Thus, tracks T1 and T2 are neighboring tracks on the carrier 1.

It should be understood that it is within the teaching of the present invention to integrate also or alternatively the control signals R_act and F_act of the control means and generate corresponding adaptive control signals in order to apply one or more adaptive control signals when the focused beam 5.c re-enters the surface defect A1. This is however a more indirect approach as the position and relative radial velocity of the radiation beam 5 upon leaving the first defect area (A1) can only be retrieved from these control signals through already processed signals.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical apparatus capable of reproducing/recording information from/to an associated optical carrier (1), the apparatus comprising:
control means (9, 21) capable of positioning and focusing a radiation beam (5) on the associated optical carrier, the associated optical carrier comprising optical readable effects arranged in tracks (T1, T2) and/or being adapted for recording optical readable effects,
photo detection (10) means for detection of radiation (8) reflected from the associated optical carrier, said photo detection means being adapted for generating error signals (RE, FE) indicative of a difference between a target position and an actual position of the focussed radiation beam (5) on the carrier,
a servomechanism adapted to change the position of the focussed radiation beam (5) on the associated optical carrier (1) in response to at least one of said error signals (RE, FE) by generating corresponding control signals (R_act, F_act) and applying said control signals (R_act, F_act) on the control means (9, 21),
defect detection means (DEFO) for detection of one or more surface defect areas (A1, A2) on the associated optical carrier, and
processing means (50, INT) adapted for integrating one or more error signals (RE, FE) as the focussed radiation beam (5.b) is exiting a first defect area (A1), as indicated by the defect detection means (DEFO), for generating one or more adaptive control signals (AD_RE, AD_FE), said first defect area (A1) being positioned in a first track (T1),
wherein the optical system is adapted to apply the one or more adaptive control signals (AD_RE, AD_FE) on the control means (9) when the focussed radiation beam (5.c) is positioned in the first defect area (A1) again on a subsequent, second track (T2), said first (T1) and second (T2) tracks being adjacent tracks on the associated optical carrier.

2. An optical apparatus according to claim 1, wherein the optical system is adapted to apply the one or more adaptive control signals (AD_RE, AD_FE) on the control means when the focussed radiation beam enters the first defect area (A1).

3. An optical apparatus according to claim 1, wherein the integrated value of the one or more error signals (RE, FE) is multiplied by a gain constant so as to generate the one or more adaptive control signals (AD_RE, AD_FE).

4. An optical apparatus according to claim 1, wherein the processing means (50, DIF) are further adapted for differentiating one or more error signals (RE, FE) as the focussed radiation beam is exiting the first defect area (A1) for generating one or more adaptive control signals (AD_RE, AD_FE).

5. An optical apparatus according to claim 4, wherein the one or more adaptive control signals (AD_RE, AD_FE) comprises a substantially square-shaped pulse.

6. An optical apparatus according to claim 4, wherein the one or more adaptive control signals (AD_RE, AD_FE) comprises two substantially square-shaped pulses having opposite polarity.

7. An optical apparatus according to claim 3, wherein the one or more adaptive control signals (AD_RE, AD_FE) is adapted so that the position of the focussed radiation beam is substantially on said second track (T2) as the focussed radiation beam leaves the first defect area (A1).

8. An optical apparatus according to claim 3, wherein the one or more adaptive control signals (AD_RE, AD_FE) is adapted so that the focussed radiation beam has substantially zero velocity in a direction perpendicular to said second track (T2) as the focussed radiation beam leaves the first defect area (A1).

9. A method for operating an optical apparatus capable of reproducing/recording information from/to an associated optical carrier (1), the method comprising the steps of:
1) positioning and focusing a radiation beam on the associated optical carrier by control means (9, 21), the associated optical carrier comprising optical readable effects arranged in tracks (T1, T2) and/or being adapted for recording optical readable effects,
2) detection of radiation (8) reflected from the associated optical carrier by photo detection means (10), said photo detection means being adapted for generating error signals (RE, FE) indicative of a difference between a target position and an actual position of the focussed radiation beam on the carrier (1),
3) providing a servomechanism adapted to change the position of the focussed radiation beam (5) on the associated optical carrier in response to at least one of said error signals (RE, FE) by generating corresponding control signals (R_act, F_act) and applying said control signals (R_act, F_act) on the control means (9, 21),
4) detection of one or more surface defect areas (A1, A2) on the associated optical carrier by defect detection means (DEFO),
5) integrating one or more error signals (RE, FE) by processing means (50) as the focussed radiation beam (5.b) is exiting a first defect area (A1), as indicated by the defect detection means (DEFO), for generating one or more adaptive control signals (AD_RE, AD_FE), said first defect area (A1) being positioned in a first track (T1), and
6) applying the one or more adaptive control signals (AD_RE, AD_FE) on the control means when the focussed radiation beam (5.c) is positioned in the first defect area (A1) again on a subsequent, second track (T2), said first (T1) and second (T2) tracks being adjacent tracks on the associated optical carrier.

10. A computer program product being adapted to enable a computer system comprising at least one computer having data storage means associated therewith to control an optical apparatus according to claim 9.
